(19) United States
(12) Patent Application Publication
(10) Pub. No.: US 2020/0186765 A1
(43) Pub. Date: Jun. 11, 2020

(54) Color Corrected Projection System with Field of View Expansion Optic

(71) Applicant: Microvision, Inc., Redmond, WA (US)

(72) Inventors: Matthieu Saracco, Redmond, WA (US); Alga Lloyd Nothern, III, Seattle, WA (US); Jonathan A. Morarity, Seattle, WA (US)

(21) Appl. No.: 16/211,630

(22) Filed: Dec. 6, 2018

(51) Int. Cl. H04N 9/31; G02B 27/00; G03B 21/20

(52) U.S. Cl. CPC H04N 9/3182; G02B 27/005; H04N 9/3135; G03B 21/2013; H04N 9/3155; G03B 21/2033; H04N 9/3161

(57) ABSTRACT

Chromatic aberrations are corrected on a first axis of a lens system by the lens system itself. Chromatic aberrations caused by the lens system on a second axis of the lens system are compensated for by varying the timing of laser light pulses of different wavelengths. In visible projection systems, red, green, and blue laser light pulses for a single display pixel are produced at different times as a function of pixel position.

### FIELD

The present invention relates generally to display systems, and more specifically to the treatment of chromatic aberrations in display systems.

### BACKGROUND

Laser beam scanning display systems typically scan a white light beam composed of red, green, and blue laser beams on a planar surface using a scanner that moves the beam on two axes. Various distortion mechanisms may cause distortions in the resultant image, including distortions caused by the relative geometry between light sources and scanners, and chromatic aberrations caused by optical devices in the light path.

FIG. 1 shows a cross section of a prior art laser scanning module 100 that includes laser light sources 102, beam combining optics 110, scanning device 120, and optical device 130. Laser light sources 102 typically source red, green, and blue laser light beams that are combined into a single beam by beam combining optics 110 before being scanned by scanning device 120. The beam scanned by scanning device 120 then passes through optical device 130, which expands the field of view to create a resultant image (not shown).

FIGS. 2 and 3 show typical prior art image distortions. Both figures show keystoning that is present in part because the scanning device is fed from below. Both figures also show chromatic aberrations caused by dispersion of the different color light beams as they pass through optical device 130. The sizes of the spots in FIG. 2 represent a typical displacement between blue and green laser beams at various pixel locations that result from dispersion caused by optical device 130. Likewise, the sizes of the spots in FIG. 3 represent a typical displacement between red and green laser beams at various pixel locations that result from dispersion caused by optical device 130. Distortions such as those shown in FIGS. 2 and 3 are generally undesirable.

### BRIEF DESCRIPTION OF THE DRAWINGS

FIG. 1 shows a cross section of a prior art laser scanning module;

FIGS. 2 and 3 show distortion and chromatic aberration present in the prior art laser scanning module of FIG. 1;

FIG. 4 shows a block diagram of a scanning laser projection system in accordance with various embodiments of the present invention;

FIGS. 5-8 show distortion and chromatic aberration corrected by various embodiments of the present invention;

FIG. 9 shows a perspective view of a slow-scan chromatic aberration correcting optical device in accordance with various embodiments of the present invention;

FIG. 10 shows a cross section of a laser scanning module in accordance with various embodiments of the present invention;

FIG. 11 shows a perspective view of a laser scanning module in accordance with various embodiments of the present invention;

FIGS. 12 and 13 show residual chromatic aberration not corrected by the laser scanning module shown in FIGS. 10 and 11;

FIG. 14 shows a fast-scan chromatic aberration compensation circuit in accordance with various embodiments of the present invention;

FIG. 15 shows a flow diagram of methods in accordance with various embodiments of the present invention;

FIG. 16 shows a block diagram of a mobile device in accordance with various embodiments of the present invention;

FIG. 17 shows a short throw projector in accordance with various embodiments of the present invention; and

FIG. 18 shows a mobile device in accordance with various embodiments of the present invention.

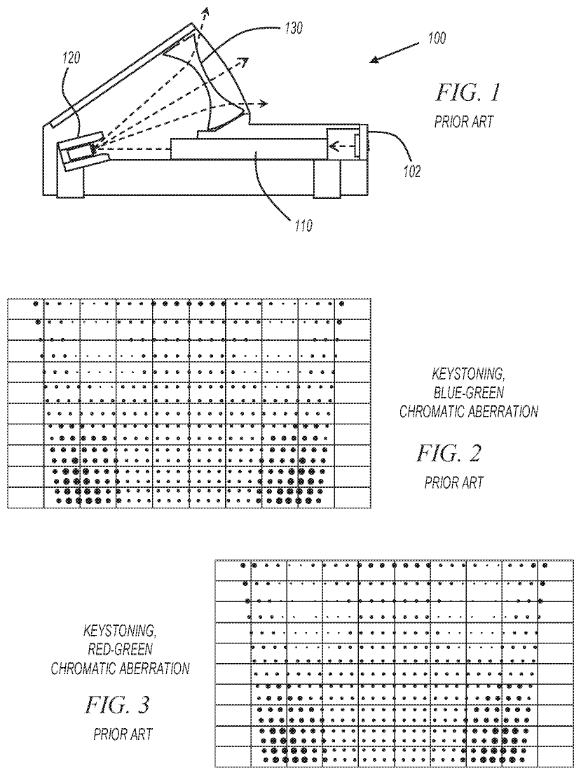

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

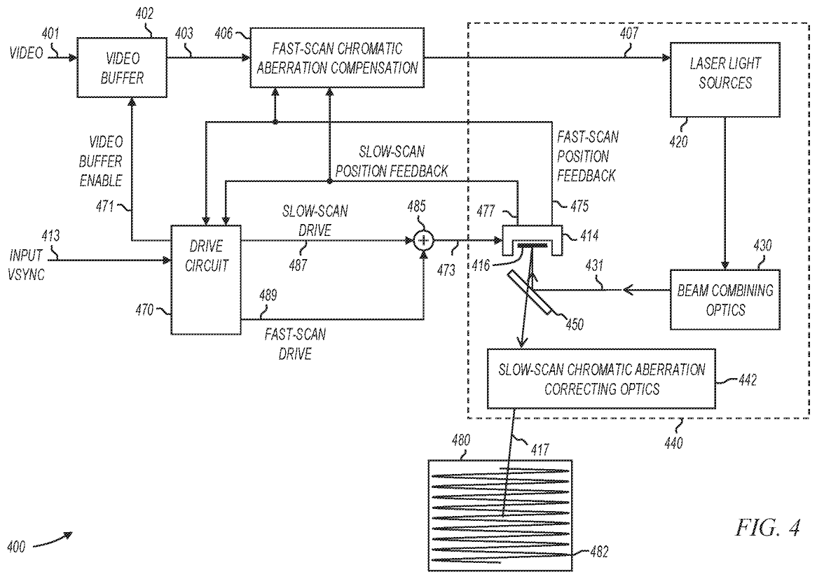

FIG. 4 shows a block diagram of a scanning laser projection system in accordance with various embodiments of the present invention. Scanning laser projection system 400 includes video buffer 402, laser scanning module 440, drive circuit 470, summer 485, and fast-scan chromatic aberration compensation circuit 406.

In operation, video buffer 402 stores one or more rows of video content at 401 and provides drive values on node 403 starting when commanded by drive circuit 470 through the video buffer enable signal 471. The commanded drive values correspond to electrical currents for visible light sources within laser scanning module 440 (e.g., red, green, and blue laser diodes) such that the output intensity from the laser light sources is consistent with the input video content. In some embodiments, this process occurs at output pixel rates in excess of 150 MHz.

In some embodiments, the video data arrives row by row. For example, the first video data received may correspond to an upper left pixel in an image. Succeeding video data represents the remainder of the pixels in the top row from left to right, and then further rows from top to bottom. When the bottom right of the image is reached, then a complete “frame” of video data has been supplied. The rate at which frames of video data are received is referred to herein as the “frame rate.” In typical applications, an input vertical sync (VSYNC) signal 413 is received with the video data and is asserted once per frame. Accordingly, the input VSYNC is periodic at the frame rate.

Laser scanning module 440 includes laser light sources 420, beam combining optics 430, fold mirror 450, scanning device 414, and slow-scan chromatic aberration correcting optics 442. In some embodiments, laser light sources 420 include at least two laser light sources that emit light of different wavelengths. For example, in some embodiments, laser light sources 420 include a first laser diode that emits red light and a second laser diode that emits green light. Also for example, in some embodiments, laser light sources 420 include a third laser diode that emits blue light. In still further embodiments, laser light sources 420 includes a fourth laser diode that emits infrared (IR) light. These and other embodiments are described further below. The terms “red,” “green,” and “blue” are used herein to refer to wavelengths that are perceived by a human eye as that particular color. For example, “red” refers to any wavelength of light that a human may perceive as the color red, “green” refers to any wavelength of light that a human may perceive as the color green, and “blue” refers to any wavelength of light that a human may perceive as the color blue.

Beam combining optics 430 includes one or more optic devices that combine laser light received from laser light sources 420. This combined laser beam is reflected off fold mirror 450 and directed to scanning mirror 416 within scanning device 414. In some embodiments, fold mirror 450 is included in beam combining optics 430, and in other embodiments, fold mirror 450 is omitted.

In some embodiments, scanning mirror 416 is an ultra-high speed gimbal mounted two dimensional bi-axial laser scanning mirror. In some embodiments, this bi-axial scanning mirror is fabricated from silicon using MEMS processes. In some embodiments, two independent MEMS mirrors are employed in a combined optical system, each responsible for one of the scan axes. One axis of rotation is operated quasi-statically and creates a sawtooth raster trajectory. This axis is also referred to as the slow-scan axis. The second axis of rotation is orthogonal to the first and is operated on a resonant vibrational mode of the scanning mirror. In some embodiments, the MEMS device uses electromagnetic actuation, achieved using a miniature assembly containing the MEMS die and small subassemblies of permanent magnets and an electrical interface, although the various embodiments are not limited in this respect. For example, some embodiments employ electrostatic or piezoelectric actuation. Any type of mirror actuation may be employed without departing from the scope of the present invention. In some embodiments, the slow-scan axis corresponds to the vertical axis and the fast-scan axis corresponds to the horizontal axis, although this is not a limitation of the present invention. For example, a rotation of the projector may result in the fast-scan axis being the vertical axis and the slow-scan axis being the horizontal axis

In some embodiments, raster scan 482 is formed by combining a sinusoidal component on the horizontal fast-scan axis and a sawtooth component on the vertical slow-scan axis. In these embodiments, output beam 417 sweeps sinusoidally on the horizontal (back and forth left-to-right) axis, and sweeps vertically (top-to-bottom) in a sawtooth pattern with the display blanked during flyback (bottom-to-top). FIG. 4 shows the sinusoidal pattern as the beam sweeps vertically top-to-bottom, but does not show the flyback from bottom-to-top. In other embodiments, the vertical sweep is controlled with a triangular wave such that there is no flyback. In still further embodiments, the vertical sweep is sinusoidal or a non-symmetric scanning pattern. The various embodiments of the invention are not limited by the waveforms used to control the vertical and horizontal sweep or the resulting raster pattern.

Slow-scan chromatic aberration correcting optics 442 is an optical device that receives the light beam from the scanning mirror, expands the field of view, and corrects for chromatic aberrations on the vertical slow-scan axis. Slow-scan chromatic aberration correcting optics 442 may also correct other distortions such as keystone distortion and smile distortion. Example embodiments of slow-scan chromatic aberration correcting optics are described further below with reference to later figures.

A mirror drive circuit 470 provides a slow-scan drive signal on node 487 and a fast-scan drive signal on node 489. The fast-scan drive signal on node 489 includes an excitation signal to control the resonant angular motion of scanning mirror 416 on the fast-scan axis, and the slow-scan drive signal includes an excitation signal to cause deflection on the slow-scan axis. The slow-scan and fast-scan drive signals are combined by summer 485 to produce a drive signal on node 473 used to drive MEMS device 414. The resulting mirror deflection on both the fast and slow-scan axes causes output beam 417 to generate a raster scan 482 in field of view 480. In video projection operation, the laser light sources produce light pulses for each output pixel and scanning mirror 416 reflects the light pulses as beam 417 traverses the raster pattern.

Mirror drive circuit 470 receives a fast-scan position feedback signal from scanning device 414 on node 475, and also receives a slow-scan position feedback signal on node 477. The fast-scan position feedback signal on node 475 provides information regarding the position of scanning mirror 416 on the fast-scan axis as it oscillates at a resonant frequency. In some embodiments, the fast-scan position feedback signal describes the instantaneous angular position of the mirror, and in other embodiments, the feedback signal is periodic at the frequency of oscillation. The slow-scan position feedback signal on node 477 provides information regarding the position of scanning mirror 416 on the slow-scan axis. In some embodiments, the slow-scan position feedback signal is used to phase lock movement on the slow-scan axis to the period of the input VSYNC signal received on node 413. In these embodiments, the frequency of movement on the slow-scan axis is dictated by a received sync signal (in this case, the input VSYNC).

Scanning device 414 may include any suitable circuit elements to sense mirror position on the fast-scan axis and slow-scan axis. For example, in some embodiments, scanning device 414 includes piezoelectric sensors to sense mirror position on the two axes. In some embodiments, scanning device 414 includes one or more analog-to-digital converters to digitize sensed position information. In these embodiments, either or both of the fast-scan feedback signal and the slow-scan position feedback signal are digital representations of the mirror position on the two axes. In other embodiments, the feedback signals are analog signals, and drive circuit 470 includes one or more analog-to-digital converters to digitize the feedback signals as appropriate.

Drive circuit 470 may be implemented in hardware, a programmable processor, or in any combination. For example, in some embodiments, drive circuit 470 is implemented in an application specific integrated circuit (ASIC). Further, in some embodiments, some of the faster data path control is performed in an ASIC and overall control is provided by a software programmable microprocessor.

Fast-scan chromatic aberration compensation circuit 406 receives the commanded drive values on node 403 and electronically compensates for chromatic aberrations on the fast-scan axis by separately varying the timing of the drive values for each laser light source as a function of mirror position as represented by the fast-scan position feedback signal and the slow-scan position feedback signal. As a result, the timing of drive signals presented to the laser light sources on node 407 compensate for dispersion on the fast-scan axis caused by slow-scan chromatic aberration correcting optics 442. In some embodiments, fast-scan chromatic aberration compensation circuit 406 also corrects for image distortions such as keystone distortion. Various embodiments of fast-scan chromatic aberration compensation circuit 406 are described further below with reference to later figures.

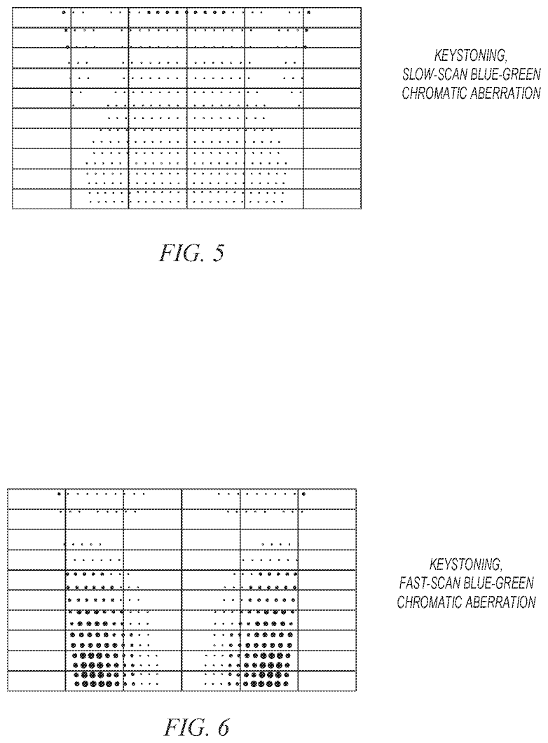

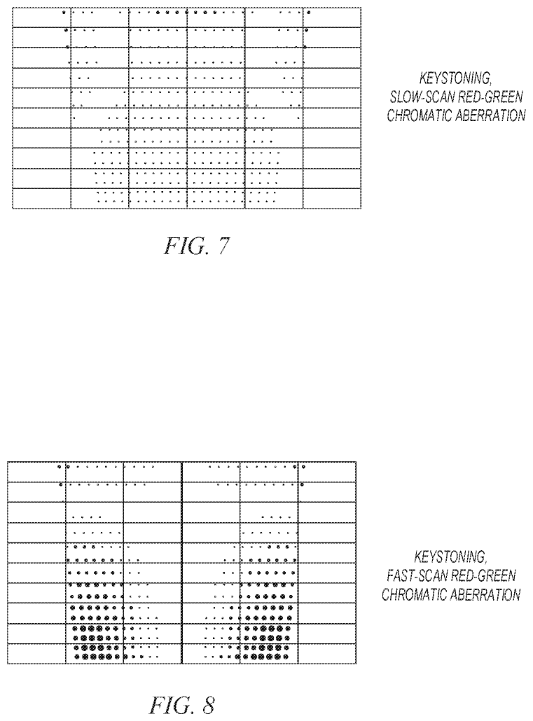

FIGS. 5 and 6 show distortion and chromatic aberration between blue and green laser beams corrected by embodiments of the present invention. FIG. 5 shows blue-green chromatic aberrations on the slow-scan axis and FIG. 6 show blue-green chromatic aberrations on the fast-scan axis. The spot sizes in FIG. 5 represent a typical displacement between blue and green laser beams on the vertical slow-scan axis at various pixel locations that result from dispersion caused by system optical devices when left uncorrected. The spot sizes in FIG. 6 represent a typical displacement between blue and green laser beams on the horizontal fast-scan axis at various pixel locations that result from dispersion caused by system optical devices when left uncorrected. Similarly, FIGS. 7 and 8 show chromatic aberrations between red and green laser beams corrected by embodiments of the present invention.

The chromatic aberrations on the slow-scan axis shown in FIGS. 5 and 7 are corrected by slow-scan chromatic aberration correcting optics 442 (FIG. 4), and the horizontal fast-scan chromatic aberrations shown in FIGS. 6 and 8 are compensated for by operation of fast-scan chromatic aberration compensation circuit 406. In some embodiments, the keystone distortion show in FIGS. 5-8 is corrected by slow-scan chromatic aberration correcting optics 442 (FIG. 4), and in other embodiments, the keystone distortion is corrected by operation of fast-scan chromatic aberration compensation circuit 406. In still further embodiments, the keystone distortion is partially corrected by by slow-scan chromatic aberration correcting optics 442 and partially corrected by fast-scan chromatic aberration compensation circuit 406.

The design and manufacture of slow-scan chromatic aberration correcting optics 442 is simplified by limiting the chromatic aberration correction to the slow-scan axis. As shown in FIGS. 5-8, the chromatic aberrations on the slow-scan axis are considerably smaller than the chromatic aberrations on the fast scan axis when the scanning device is fed from below. In addition, electronic compensation for the larger chromatic aberrations on the fast-scan axis can be more complete, in part because the timing of each laser beam pulse of each color can be independently controlled as a function of mirror position (pixel position).

FIG. 9 shows a perspective view of a slow-scan chromatic aberration correcting optical device in accordance with various embodiments of the present invention. Optical device 442 includes lens 910 and lens 920. Each of lenses 910 and 920 include two rotationally asymmetric free form surfaces. The design shown has refractive optical surfaces; however, some embodiments include reflective surfaces, and still other embodiments include a combination of reflective and refractive surfaces.

In some embodiments, lens 910 and 920 are shaped to correct for keystone distortion. Lenses 910 and 920 also have different indices of refraction and/or Abbe number to correct for chromatic aberrations on the vertical fast-scan axis. For example, in some embodiments, lens 910 is made of a plastic material with an index of refraction (n) between 1.51 and 1.53 and an Abbe number of 56, and lens 920 is made of a polycarbonate material with n=1.63-1.68 and an Abbe number of 23. These indices of refraction and Abbe numbers are provided as examples and the various embodiments of the present invention may include lenses having higher or lower indices of refraction and higher or lower Abbe numbers.

In some embodiments, lenses 910 and 920 may be designed according to, and described by, polynomials. The present invention is not limited by the type or number of polynomials that are used to describe lens or mirror surfaces.

In some embodiments, lenses 910 and 920 may be designed according to, and described by, Chebyshev polynomials. For example, using a finite sum of Chebyshev polynomial terms, the resulting sag equation may take the form:

$$z = \frac{c ( {x}^{2} + {y}^{2} )}{1 + \sqrt{1 - {c}^{2} ( {x}^{2} + {y}^{2} )}} + {\sum }_{i = 0}^{N} {\sum }_{j = 0}^{M} {a}_{ij} \cdot {T}_{i} ( \overline{x} ) \cdot {T}_{j} ( \overline{y} ) \qquad ( 1 )$$

where:

z is the sag of the surface parallel to the z-axis;

c is the vertex curvature;

aᵢⱼ are the coefficients of the Chebyshev polynomial sum;

x̅, y̅ are normalized surface coordinates; and

N and M are the maximum polynomial orders in x and y dimensions.

The first ten Chebyshev polynomial coefficients are given by:

T₀(x)=1;

T₁(x)=x;

T₂(x)=2x²−1;

T₃(x)=4x³−3x;

T₄(x)=8x⁴⁻8x²+1;

T₅(x)=16x⁵−20x³+5x;

T₆(x)=32x⁶−48x⁴+18x²−1;

T₇(x)=64x⁷−112x⁵+56x³−7x;

T₈(x)=128x⁸−256x⁶+160x⁴−32x²+1;

T₉(x)=256x⁹−576x⁷+432x⁵−120x³+9x; and

T₁₀(x)=512x¹⁰−1280x⁸+1120x⁶−400x⁴+50x²−1.

In other embodiments, lenses 910 and 920 may designed according to, and described by, Zernike polynomials. For example, Zernike polynomial surface equations may take the form:

$$z = \frac{{cr}^{2}}{1 + \sqrt{1 - ( 1 + k ) {c}^{2} {r}^{2}}} + {\sum }_{j = 1}^{66} {C}_{( j + 1 )} {ZP}_{j} \qquad ( 2 )$$

where:

z is the sag of the surface parallel to the z-axis;

c is the vertex curvature;

k is the conic constant;

r is the radial distance=\sqrt{x²+y²};

ZPⱼ is the j^{th} Zernike polynomial (range of j: 1 to 66);

C₍ⱼ₊₁₎ is the coefficient for ZPⱼ; and

TABLE 1
Zernike Coefficients

| Coefficient | Alias | Definition |
|---|---|---|
| C₁ | K | Conic Constant |
| C₂ | ZP₁ | 1^{st} Zernike Coefficent |
| C₃ | ZP₂ | 2^{nd} Zernike Coefficent |
| C₄ | ZP₃ | 3^{rd} Zernike Coefficent |
| . . . | | |
| C₍ₙ₊₁₎ | ZPₙ | n^{th} Zernike Coefficent |
| . . . | | |
| C₆₅ | ZP₆₄ | 64^{th} Zernike Coefficent |
| C₆₆ | ZP₆₅ | 65^{th} Zernike Coefficent |
| C₆₇ | ZP₆₆ | 66^{th} Zernike Coefficent |
| C₆₉ | Normalized Radius | Normalization Radius |

In still further embodiments, polynomials describing free form surfaces of lenses and/or mirrors may include extended polynomial terms and take the form:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) \qquad ( 3 )$$

where:

z is the sag of the surface parallel to the z-axis;

c is the vertex curvature;

k is the conic constant;

r is the radial distance=\sqrt{x²+y²};

N is the number of extended polynomial terms;

Aᵢ is the coefficient on the i^{th} extended polynomial term; and

Eᵢ is the i^{th} extended polynomial term.

The polynomial terms E are a power series in x and y. The first term is x, then y, then x², xy, y², etc.

Various embodiments of the slow-scan chromatic aberration correcting optics employ different lens designs to achieve various combinations of field of view expansion, keystone correction, and chromatic aberration correction on the slow-scan axis.

A variety of techniques may be used for determining polynomial coefficients and other parameters used to determine shapes and material properties of lenses 910 and 920 to achieve field of view expansion, keystone distortion correction, and chromatic aberration correction on the vertical slow-scan axis. For example, the optimization of all surfaces in the lenses may be determined together along with material choices with the corresponding indices of refraction and Abbe numbers.

As one example, a merit function can be provided that defines the various constraints and goals of the projected image. For example, the merit function can define target levels of field of view expansion, keystone distortions at various projection distances, and chromatic aberration targets on the vertical slow-scan axis. Other potential parameters and constraints in the merit function may include target laser spot size, ratio of laser spot size to pixel image size, image size target and horizontal or vertical line spacing targets.

Various embodiments of the present invention weight some of these parameters and constraints more or less in the merit function depending on specific needs. For example, in some embodiments it may be desirable to heavily weight a target spot size. In other embodiments it may be desirable to limit the amount of work done by a particular lens surface. For example, it may be desirable to increase the amount of work done by reflective surfaces compared to the work done by refractive surfaces to reduce the amount of chromatic aberration that would otherwise occur in the refractive surfaces. With these and other parameters included in the merit function, optical optimization software can be used to find a local or global minimum of the merit function and provide the ability to make appropriate tradeoffs. Thus, the parameters can be determined that precisely define the surface shapes and material properties (e.g., index of refraction, Abbe number) of lens 910 and lens 920.

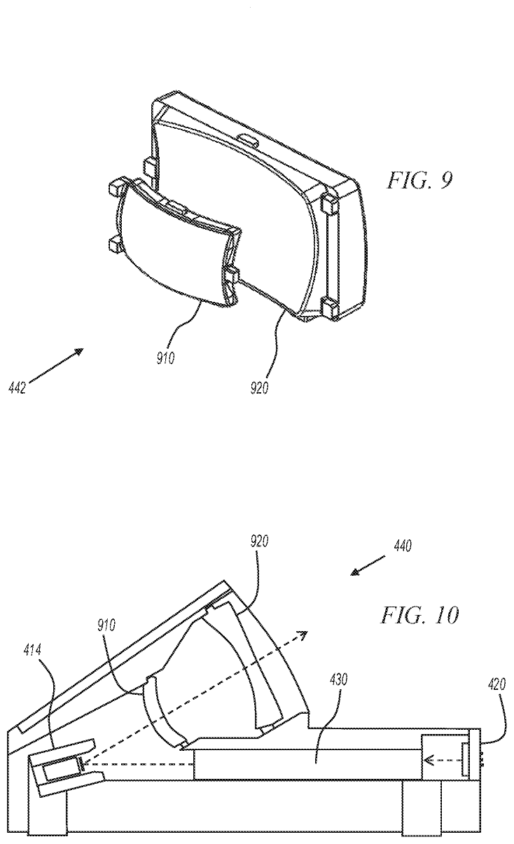

FIG. 10 shows a cross section of a laser scanning module in accordance with various embodiments of the present invention. Laser scanning module 440 is an example embodiment of module 440 (FIG. 4). Laser scanning module 440 includes laser light sources 420, combining optics 430, scanning device 414, and a slow-scan chromatic aberration correcting optical device that includes lens 910 and lens 920.

In some embodiments, laser light sources 420 emit visible light such as red, green, and blue light. In other embodiments, laser light sources 420 emit nonvisible light such as IR light. In still further embodiments, laser light sources 420 emit a combination of visible and nonvisible light. In operation, laser light sources 420 emit light that is collimated, focused, and combined by optics 430. Optics 430 may include mirrors, dichroic mirrors, polarization rotating devices, and polarizing beam splitters and/or combiners as appropriate depending on the number and wavelengths of light beams to be combined. Scanning device 414 receives the combined output beam from optics 430. In some embodiments, as shown in FIG. 10, scanning device 414 is “bottom fed.” As used herein the term “bottom fed” refers to the scanning device receiving the combined laser beam from below the slow-scan chromatic aberration correcting optical device. For example, as shown in FIG. 10, combining optics are positioned beneath lenses 910 and 920, and feed the combined laser beam to the scanning device from beneath lenses 910 and 920.

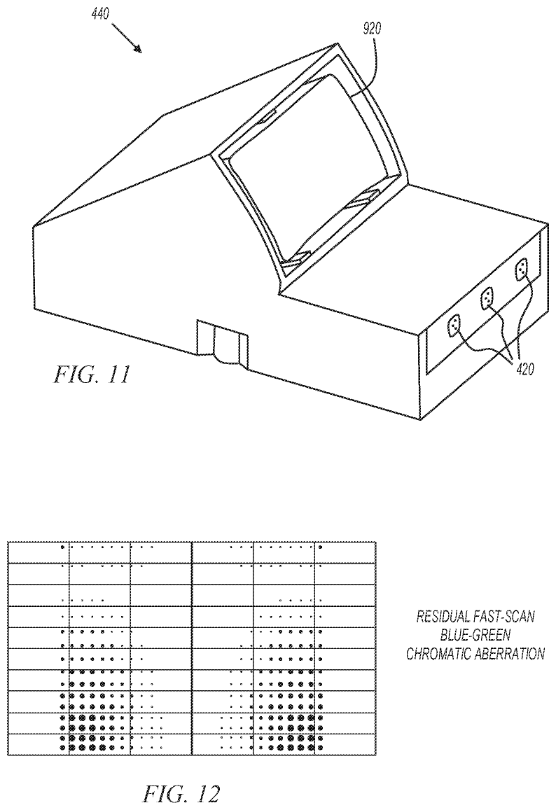

FIG. 11 shows a perspective view of a laser scanning module in accordance with various embodiments of the present invention. The perspective view of laser scanning module 440 corresponds to the cross sectional view shown in FIG. 10. Lens 920 is shown, and laser light sources 420 are shown with electrical connections.

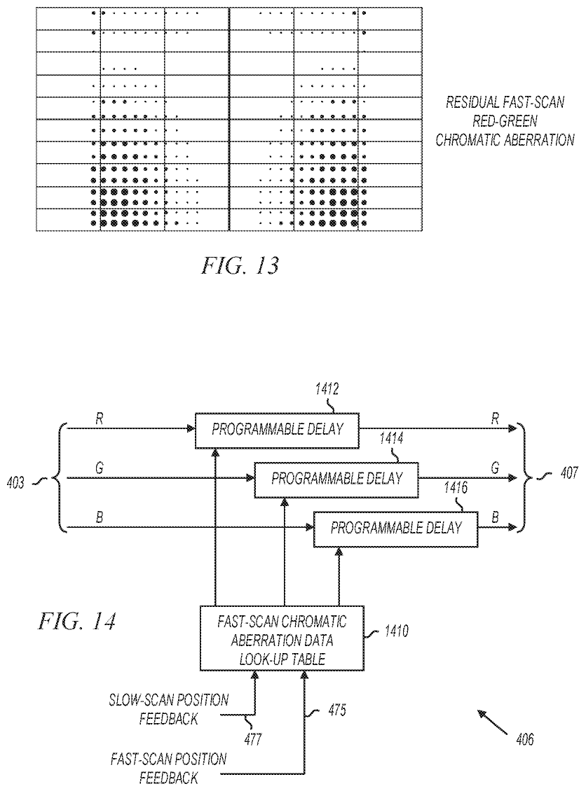

FIGS. 12 and 13 show residual chromatic aberrations not corrected by the laser scanning module shown in FIGS. 10 and 11. As described above, the slow-scan chromatic aberration correcting optical device 442 corrects chromatic aberrations on the slow-scan axis, and in some embodiments, also corrects some image distortions such as keystone distortion. FIGS. 12 and 13 show the fast-scan chromatic aberrations that are not corrected by laser scanning module 440 in embodiments in which slow-scan chromatic aberration correcting optical device 442 corrects for both chromatic aberration on the slow-scan axis as well as keystone distortion. The spot sizes in FIG. 12 represent the displacement between blue and green laser beams on the horizontal fast-scan axis at various pixel locations that result from dispersion caused by optical device 442. Similarly, the spot sizes in FIG. 13 represent the displacement between red and green laser beams on the horizontal fast-scan axis at various pixel locations that result from dispersion caused by optical device 442.

FIG. 14 shows a fast-scan chromatic aberration compensation circuit in accordance with various embodiments of the present invention. Fast-scan chromatic aberration circuit 406 includes programmable delay elements 1412, 1414, and 1416, which function to separately delay the laser drive values for the red, green, and blue laser light sources, respectively. Each of the programmable delay elements are responsive to delay values stored in fast-scan chromatic aberration data look-up table 1410. In some embodiments, the data in table 410 represents the inverse of the chromatic aberration caused by the system optics, and in other embodiments, the data in table 410 represents a combination of the inverse of the chromatic aberration caused by the system optics and the inverse of the keystone distortion the results from the feed direction. Data in look-up table 1410 is addressed by the pixel position represented by the slow-scan position feedback on node 177 and the fast scan position feedback on node 475. In response the pixel position, the red, green, and/or blue laser source drive values are delayed in a manner that compensates for chromatic aberrations on the horizontal fast scan axis, and in some embodiments, also corrects for keystone distortion.

In some embodiments, delay values are determined mathematically as a function of pixel position. For example, in some embodiments, polynomials that represent the chromatic aberrations are produced as part of the design process, and these polynomials are used to determine delay values to compensate for chromatic aberrations.

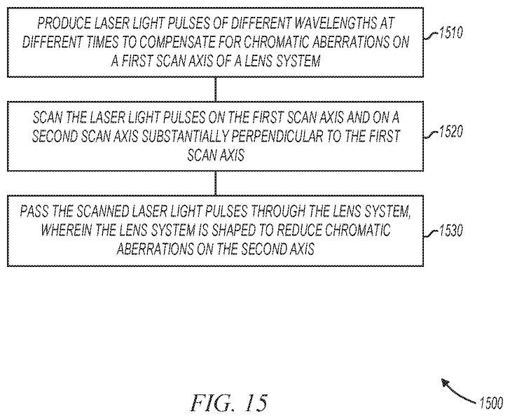

FIG. 15 shows a flow diagram of methods in accordance with various embodiments of the present invention. In some embodiments, method 1500, or portions thereof, is performed by a scanning laser projection system. In other embodiments, method 1500 is performed by a series of lenses or an optical system. Method 1500 is not limited by the particular type of apparatus performing the method. The various actions in method 1500 may be performed in the order presented, or may be performed in a different order. Further, in some embodiments, some actions listed in FIG. 15 are omitted from method 1500.

Method 1500 is shown beginning with block 1510. As shown at 1510, laser light pulses of different wavelengths are produced at different times to compensate for chromatic aberrations on a first scan axis of a lens system. For example, the timing of laser light source drive signals may be individually controlled to compensate for chromatic aberrations on a fast-scan axis of lens system. In some embodiments, red, green, and blue laser light pulses are produced for a single display pixel at different times that are a function of pixel position.

At 1520, the laser light pulses are scanned on the first scan axis and on a second scan axis substantially perpendicular to the first scan axis. For example, a scanning mirror may scan sinusoidally on the first scan axis and non-sinusoidally on the second scan axis. In some embodiments, the laser light pulses are scanned using a single biaxial scanning mirror, and in other embodiments, the laser light pulses are scanned using two scanning mirrors, at least one of which may be resonant.

At 1530, the scanned laser light pulses are passed through the lens system, where the lens system is shaped to reduce chromatic aberrations on the second axis. In some embodiments, the lens system includes two lenses having different indices of refraction and Abbe number as described above. In some embodiments, the lens system may also expand a field of view and correct for other distortions, such as keystone distortion.

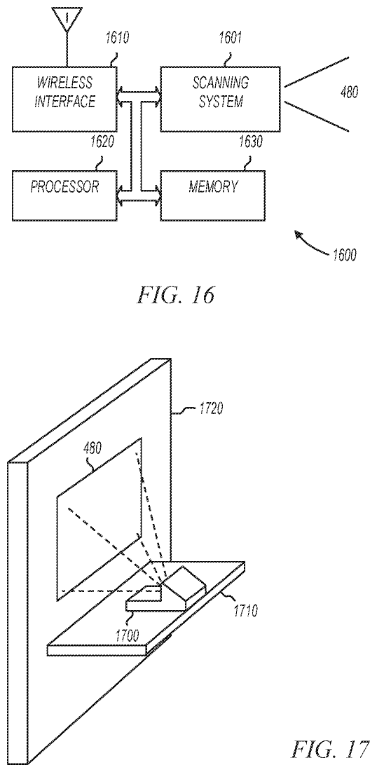

FIG. 16 shows a block diagram of a mobile device in accordance with various embodiments of the present invention. As shown in FIG. 16, mobile device 1600 includes wireless interface 1610, processor 1620, memory 1630, and scanning system 1601. Scanning system 1601 includes any of the fast-scan chromatic aberration compensation circuits and/or slow-scan chromatic aberration correcting optical devices described above.

Scanning system 1601 may receive image data from any image source. For example, in some embodiments, scanning system 1601 includes memory that holds still images. In other embodiments, scanning system 1601 includes memory that includes video images. In still further embodiments, scanning system 1601 displays imagery received from external sources such as connectors, wireless interface 1610, a wired interface, or the like.

Wireless interface 1610 may include any wireless transmission and/or reception capabilities. For example, in some embodiments, wireless interface 1610 includes a network interface card (NIC) capable of communicating over a wireless network. Also for example, in some embodiments, wireless interface 1610 may include cellular telephone capabilities. In still further embodiments, wireless interface 1610 may include a global positioning system (GPS) receiver. One skilled in the art will understand that wireless interface 1610 may include any type of wireless communications capability without departing from the scope of the present invention.

Processor 1620 may be any type of processor capable of communicating with the various components in mobile device 1600. For example, processor 1620 may be an embedded processor available from application specific integrated circuit (ASIC) vendors, or may be a commercially available microprocessor. In some embodiments, processor 1620 provides image or video data to scanning system 1601. The image or video data may be retrieved from wireless interface 1610 or may be derived from data retrieved from wireless interface 1610. For example, through processor 1620, scanning system 1601 may display images or video received directly from wireless interface 1610. Also for example, processor 1620 may provide overlays to add to images and/or video received from wireless interface 1610, or may alter stored imagery based on data received from wireless interface 1610 (e.g., modifying a map display in GPS embodiments in which wireless interface 1610 provides location coordinates).

FIG. 17 shows a short throw projector in accordance with various embodiments of the present invention. Short throw projector 1700 is positioned on a shelf 1710 and projecting into field of view 480 onto a wall 1720. Projector 1700 includes any of the fast-scan chromatic aberration compensation circuits and/or slow-scan chromatic aberration correcting optical devices described above.

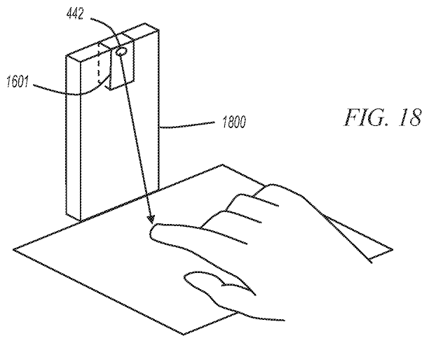

FIG. 18 shows a mobile device in accordance with various embodiments of the present invention. Mobile device 1800 includes scanning system 1601, which in turn includes slow-scan chromatic aberration correcting optical device 442. In operation, mobile device 1800 displays an image on a projection surface that may be interactive. For example, IR laser pulses may be projected in the field of view and the time-of-flight of reflected pulses may be detected to determine the distance to objects in the field of view.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

The currently pending claims are as follows:

1. A laser scanning module comprising:
a plurality of laser light sources to emit laser light pulses of different wavelengths;
a scanning device to scan the plurality of laser light pulses on a fast-scan axis and a slow-scan axis;
an optical device having a non-uniform index of refraction to reduce chromatic aberrations on the slow-scan axis; and
a chromatic aberration compensation circuit configured to separately vary a timing of drive values for each of the plurality of laser light sources as a function of scanning device position to reduce chromatic aberrations on the fast-scan axis.

2. The laser scanning module of claim 1 wherein the scanning device is fed from below the optical device resulting in keystone distortion of a resultant image when left uncorrected.

3. The laser scanning module of claim 2 wherein the optical device is shaped to reduce the keystone distortion.

4. The laser scanning module of claim 1 wherein the optical device comprises at least two lenses made of materials having different indices of refraction.

5. The laser scanning module of claim 1 wherein the optical device comprises at least two lenses made of materials having different Abbe numbers.

6. The laser scanning device of claim 5 wherein the at least two lenses are shaped according to Zernike polynomials.

7. The laser scanning device of claim 1 wherein the plurality of laser light sources comprises:
a first laser light source to emit red light;
a second laser light source to emit green light; and
a third laser light source to emit blue light.

8. The laser scanning device of claim 1 wherein the scanning mirror comprises a first scanning mirror to scan on the fast scan axis and a second scanning mirror to scan on the slow-scan axis.

9. An apparatus comprising:
a plurality of laser light sources that emit laser light pulses of different wavelengths;
a scanning mirror that scans light from the plurality of laser light sources on a fast-scan axis and on a slow-scan axis;
an optical system that includes at least two lenses with different indices of refraction, wherein the at least two lenses are shaped to correct for chromatic aberration on the slow-scan axis; and
a chromatic aberration compensation circuit to electronically compensate for chromatic aberrations on the fast scan axis, wherein the chromatic aberration compensation circuit is configured to separately vary a timing of drive values for each of the plurality of laser light sources as a function of scanning mirror position.

10. The apparatus of claim 9 wherein the chromatic aberration compensation circuit includes delay elements to modify timing of the laser light pulses emitted by the plurality of laser light sources.

11. The apparatus of claim 9 wherein the at least two lenses have freeform surface shapes described by Zernike polynomials.

12. The apparatus of claim 11 wherein the scanning mirror is fed from below the optical system resulting in keystone distortion of a resultant image when left uncorrected.

13. The apparatus of claim 12 wherein the at least two lenses are shaped to reduce the keystone distortion.

14. The apparatus of claim 9 wherein the plurality of laser light sources comprises:
a first laser light source to emit red light;
a second laser light source to emit green light; and
a third laser light source to emit blue light.

15. The apparatus of claim 14 wherein the chromatic aberration compensation circuit includes delay elements to delay one or more pulse drive signals that drive the first, second, and third laser light sources.

16. The apparatus of claim 9 wherein the scanning mirror comprises a first scanning mirror to scan on the fast scan axis and a second scanning mirror to scan on the slow-scan axis.

17. A method comprising:
producing laser light pulses of different wavelengths at different times to compensate for chromatic aberrations on a first axis of a lens system, wherein the different times are a function of a position of a scanning mirror;
scanning, with the scanning mirror, the laser light pulses on the first axis and on a second axis substantially perpendicular to the first axis; and
passing scanned laser light pulses through the lens system, wherein the lens system is shaped to reduce chromatic aberration on the second axis.

18. The method of claim 17 wherein passing scanned laser light pulses comprises passing scanned laser light pulses through a lens system wherein the lens system is further shaped to reduce keystone distortion.

19. The method of claim 17 wherein passing scanned laser light pulses comprises passing scanned laser light pulses through two lenses having different indices of refraction.

20. The method of claim 17 wherein producing laser light pulses of different wavelengths at different times comprises producing red, green, and blue laser light pulses for a single display pixel at different times.
